(19) United States
(12) Patent Application Publication
(10) Pub. No.: US 2018/0154197 A1
(43) Pub. Date: Jun. 7, 2018

(54) HORIZONTAL LIFELINES WITH SAFETY IMPROVEMENTS

(71) Applicant: Alexander Andrew, Inc. DBA Falltech, Compton, CA (US)

(72) Inventor: David Riches, St. Ives (GB)

(21) Appl. No.: 15/824,193

(22) Filed: Nov. 28, 2017

Related U.S. Application Data
(60) Provisional application No. 62/429,838, filed on Dec. 4, 2016.

(51) Int. Cl. A62B 35/00

(52) U.S. Cl. CPC A62B 35/0087; A62B 35/0037; A62B 35/0056

(57) ABSTRACT

A shuttle device for a horizontal lifeline (HLL) includes a body portion including a slot configured to bypass an intermediate bracket of the HLL. An attachment shackle is connected with the body portion. The attachment shackle is configured to rotate the body portion under a fall-arrest load such that the slot is positioned away from bearing on a cable of the HLL.

### CROSS-REFERENCE TO RELATED APPLICATIONS

This application claims the priority benefit of U.S. Provisional Patent Application Ser. No. 62/429,838, filed Dec. 4, 2016, incorporated herein by reference in its entirety.

### BACKGROUND

Horizontal lifelines (HLL) have been used for a considerable period of time to protect from falls to the ground from an elevation. However, unique problems arise when installing a HLL to a flat rooftop, which is typically installed at knee height above the walking (roof) surface.

First, workers that attach to the HLL will desire to work and travel on either side of it. This creates a need to design the intermediate bracket passing feature on the shuttle in such a manner to allow either-side use, but in doing so creates an unwanted and increased risk of inadvertent separation of the shuttle from the HLL when a fall-generated load is applied, which can lead to an injurious fall to the ground.

Second, it has become a popular to have an “on-off” feature incorporated into HLL shuttles. This allows a worker to manually and deliberately remove and re-engage a shuttle onto the HLL at any point along its length. This has the advantage of allowing universal safe connection to the HLL when the adjacent previous safe access route arrives at a point which is not at either extremity of the HLL. It also has the advantage of dispensing with the need to incorporate components at either extremity of the HLL specifically designed to allow engagement or removal of the shuttle device.

Providing such a feature on a shuttle device also creates an unwanted and increased risk of inadvertent separation of the shuttle from the HLL when a fall-generated load is applied, which can lead to an injurious fall to the ground, because of inherent strength reductions caused by the feature and particularly if a worker does not close the on-off feature correctly when re-engaging it onto the HLL.

### SUMMARY

A shuttle device for a horizontal lifeline (HLL) includes a body portion including a slot configured to bypass an intermediate bracket of the HLL. An attachment shackle is connected with the body portion. The attachment shackle is configured to rotate the body portion under a fall-arrest load such that the slot is positioned away from bearing on a cable of the HLL.

These and other features, aspects and advantages of the embodiments will become understood with reference to the following description, appended claims and accompanying figures.

### BRIEF DESCRIPTION OF THE DRAWINGS

FIGS. 1A-D show variable geometry attachment points for a HLL shuttle.

FIGS. 1E-J show an improved HLL shuttle with a frangible component, according to an embodiment.

FIGS. 2A-D show an offset attachment point for a HLL shuttle, according to an embodiment.

FIGS. 3A-B show an example of an offset attachment point for a HLL shuttle and an integral on/off mechanism, according to an embodiment.

FIGS. 4A-D show another example for an offset attachment point for an HLL shuttle and an integral on/off mechanism, according to an embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

One or more embodiments provide a shuttle device for the attachment of a worker wearing a safety harness when used in combination with a roof-mounted horizontal lifeline (HLL) based fall-arrest system. The one or more embodiments improve on previous shuttle designs by allowing the embodiments to be usable on either side of the horizontal lifeline without the necessity for manually removing and re-engaging the shuttle, whilst at the same time and according to the access route and the worker's preferences, allowing the embodiments to be manually removable and re-engageable at any point along the horizontal lifeline, whilst at the same time in a fall-arrest loading scenario minimizing the catastrophic potential for the shuttle to inadvertently disengage from the system as a result of the risks introduced by either-sided use and manual re-engagement of the shuttle after manual removal.

One embodiment includes a shuttle device with an on-off device for HLLs mounted at knee level or whereabouts, where the worker can walk on either side of the HLL alternatively without the need to remove and refit the shuttle and such that the shuttle will always pass over the intermediate brackets without manual intervention and that in the event of a fall, the slot edges of the shuttle are kept away from the track of the HLL.

In combination with the above features, one or more embodiments ensure that, in the event that a worker does not close the on-off feature mechanism correctly when re-engaging a previously removed shuttle to the HLL, or the locking part of the closing mechanism suffers mechanical failure, that in the event of fall, the on-off mechanism is always held shut, irrespective of falling attitude.

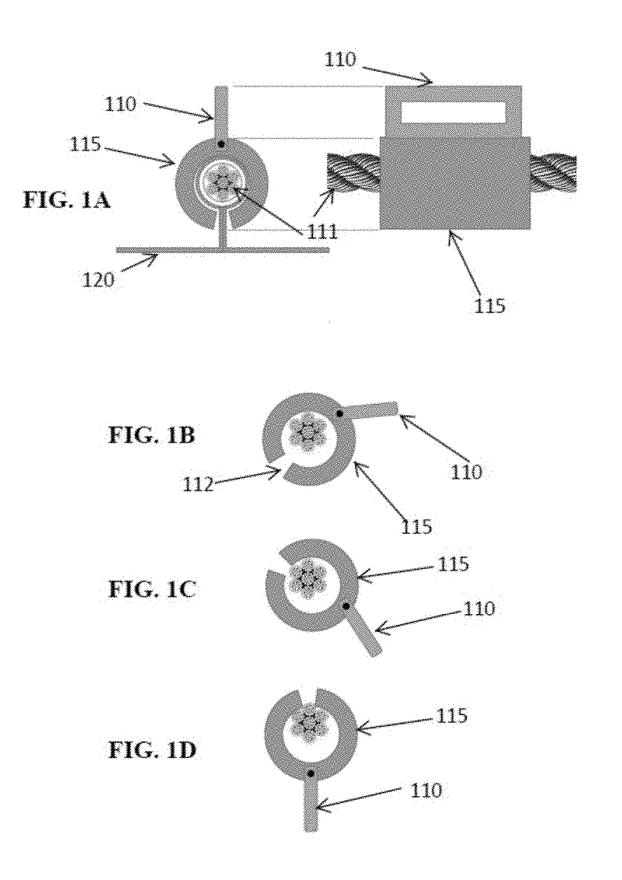

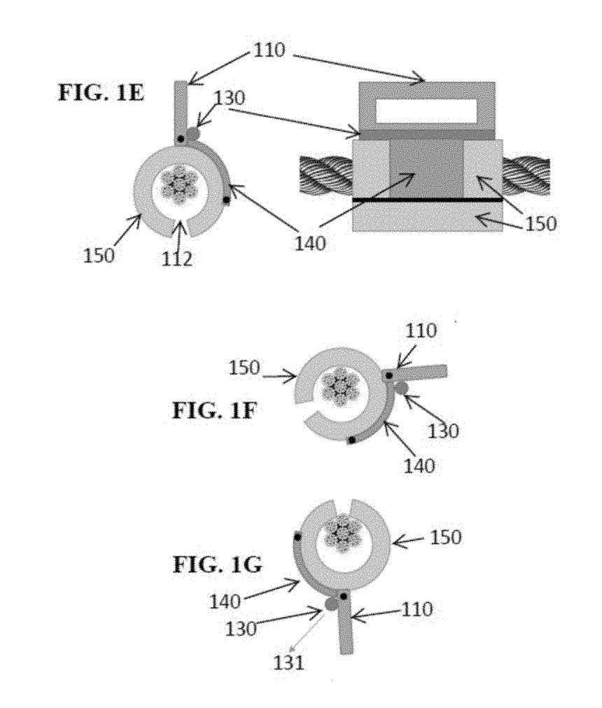

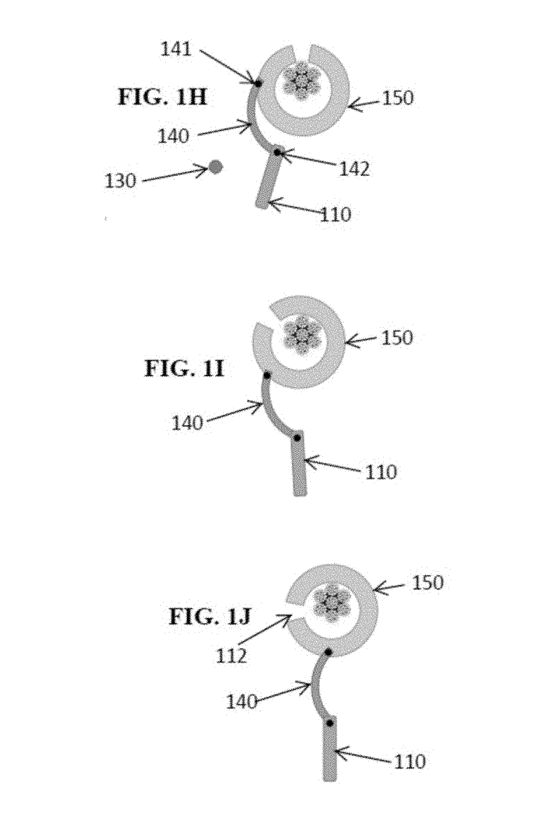

FIGS. 1A-J show variable geometry attachment point for a HLL shuttle. FIGS. 1A-J are diagrammatic in nature in order to demonstrate a principle and other features such as an “on-off” device.

One way to bypass intermediate brackets on a HLL is use of a shuttle that includes a body (or tube) 115 (FIG. 1A) and a slot 112 (e.g., FIG. 1B). The slot 112 may be made helical or chamfered at its ends to assist the slot in the shuttle to pass over a bracket 120. The bracket 120 are intermediate brackets used on an HLL for holding the wire cable/rope 111.

When designing an HLL for rooftops, which will be mounted at a level below knee height, it is important to ensure that a shuttle will bypass the intermediate brackets 120 irrespective of which side of the HLL the user is on. In order to achieve this, the attachment shackle 110 for a safety lanyard must be at the 12 o'clock position (FIG. 1A). This ensures that the slot 112 is at the 6 o'clock position (FIG. 1A) where it is generally presented to the bracket 120 irrespective of user movement.

Should a user fall on an un-bracketed part of the HLL, the shuttle is pulled by the action of the safety lanyard and revolves 180° around the wire cable/rope 111, as shown in FIGS. 1B, C and D. When the fall arrest load is applied, the slot 112 of the shuttle bears directly against the wire cable/rope 111 as shown in FIG. 1D. This tends to be the weakest and sharpest part of the shuttle and therefore, the worst point for it to be dynamically loaded in a fall situation. The slot 112 may splay open causing shuttle disengagement with the disastrous consequences of a freefall to the ground. Or the slot edges may dig into the wire cable/rope 111 in such a way that the wire cable/rope 111 is significantly weakened, which increases the risk of wire cable/rope 111 failure, again with the disastrous consequences of a freefall to the ground by a user. Further consideration must be given to another feature of the shuttle (on/off mechanisms as described below).

In one embodiment, the on/off mechanism allows the shuttle to be opened and removed and re-attached at any point on the HLL. Such a mechanism generally has a weakening effect on shuttle strength and it may inadvertently open if not closed properly. Inadvertent opening again can lead to the disastrous consequences of a freefall to the ground. Consequently, the concept of having the weakest part of the shuttle bearing on the wire cable/rope 111 in a fall situation is a bad idea.

The basic idea is to keep the attachment shackle 110 at the 12 o'clock position and the slot 112 at the 6 o'clock position (FIG. 1E), which ensures that the shuttle can pass the intermediate bracket 120 irrespective of what side of the HLL the user is on. However, in a fall, the attachment shackle 110 can move to a new position, (hence the term “variable geometry attachment point”), allowing the fall-arrest load to be applied in such a manner so that the slot 112 is kept away from bearing on the wire cable/rope 111, (FIG. 1J).

FIG. 1E shows the attachment shackle 110 being held in place by a frangible pin (e.g., pin, link, fastener, etc.) 130, according to an embodiment. The frangible pin 130 is designed to break at a certain load. The frangible pin 130 may be made of a metal alloy, a polymer-based material, etc. In one embodiment, the frangible pin 130 may be 1.5-3.00 mm in diameter and designed to break when the arrest force in safety lanyard connected to the attachment shackle 110 reaches about 506 lbs (±56 lbs.). The attachment shackle 110 is also connected to a curved metal connection 140, which itself is secured to the body 150 of the shuttle, at about the 4 o'clock position.

Should a user fall, the body 150 of the shuttle is pulled by the action of an attached safety lanyard and revolves 180° around the wire cable/rope 111, FIGS. 1F-G. However, in this situation, when the fall-arrest load begins to be applied, the pin 130 experiences the increase in force in the direction of arrow 131, (FIG. 1G) and breaks (FIG. 1H). This allows the attachment shackle 110 and curved connection 140 to break free whilst pivoting about the curved connection's attachment (fasteners 141 and 142) to the body 150 of the shuttle (FIG. 1H). Since the attachment shackle 110 is pulling at a new attachment point on the body 150 of the shuttle, this causes the body 150 of the shuttle to revolve around the wire cable/rope 111 (FIG. 1I), removing the slot 112 of the body 150 of the shuttle from the danger, until when the full force of the arrest is applied; at which point the load is applied on a stronger part of the body 150 of the shuttle (FIG. 1J).

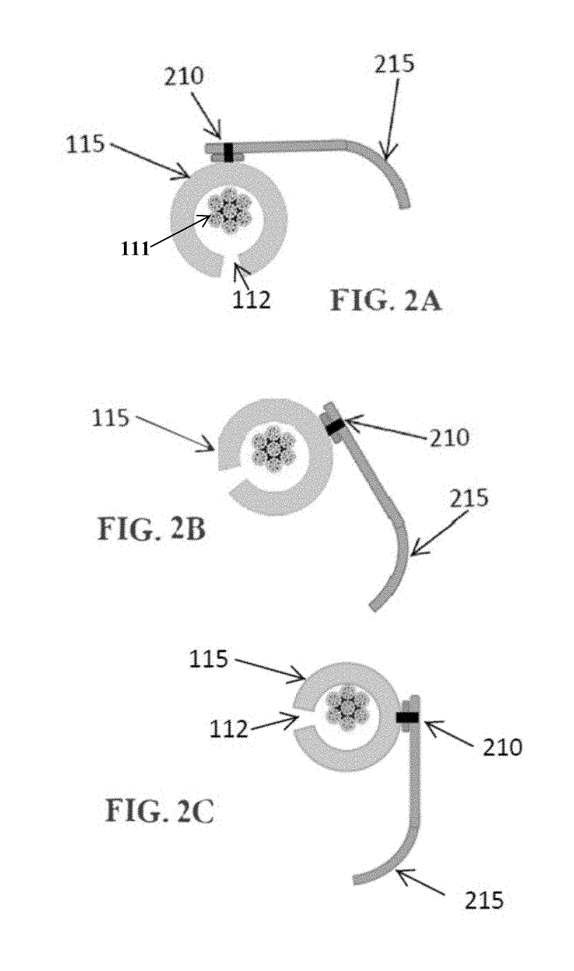

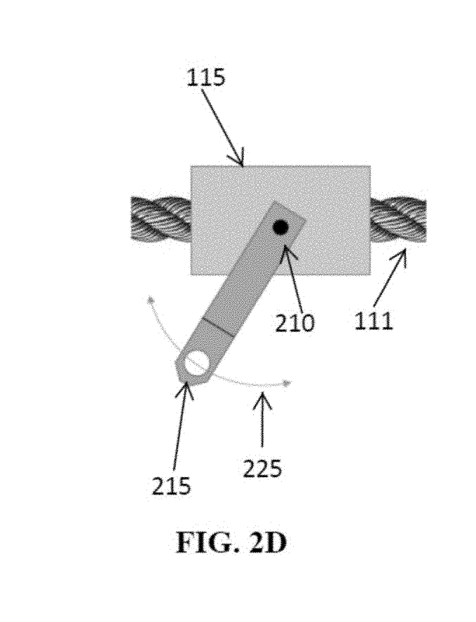

FIGS. 2A-D show an offset attachment point for the body 115 of the shuttle, according to an embodiment. FIG. 2A shows one embodiment that includes a cranked offset attachment arm 210 with a curved portion 215. The cranked offset attachment arm 210 is attached at the 12 o'clock position opposite the slot 112. The cranked offset attachment arm 210 may revolve 360° (see directional arrows 225, FIG. 2D) around the body 115 of the shuttle (see FIG. 2D, overhead view) allowing user access to both sides of the HLL, and aligns with a user's lanyard in response to user movement.

Should a user fall, the body 115 of the shuttle is pulled by the action of the safety lanyard attached to the attachment connection opening 215 (FIG. 2D) of the shuttle, and revolves around the wire cable/rope 111 (FIG. 2B). The cranked offset attachment arm 210 will pivot downward in this situation (see progression from FIG. 2A-FIG. 2C).

Due to the pivoting action of the cranked offset attachment arm 210 and its cranked geometry, the direction of the fall-arrest load will be aligned with the center of the wire cable/rope 111, which will ensure that the slot 112 in the body 115 of the shuttle will not bear on the wire cable/rope 111.

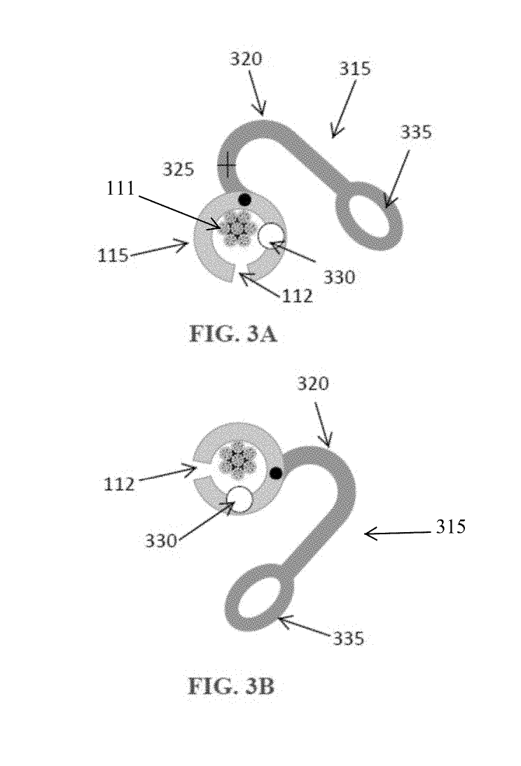

FIGS. 3A-B show an example of an offset attachment point for the shuttle and an integral on/off mechanism, according to an embodiment. One embodiment incorporates the offset arm whilst integrating it with the on-off mechanism. Apart from the previous advantage of ensuring that the slot 112 is kept away from the wire cable/rope 111 during a fall, it also provides a fail-safe feature should the on-off mechanism malfunction in any way, or if the operator fails to close the mechanism properly.

There are two main issues to consider:
(1) Ensuring that the slot 112 in the shuttle is kept away from the wire cable/rope 111 during a fall incident, eliminating potential shuttle disengagement.
(2) Ensuring that malfunction or incorrect closure of the on-off mechanism does not create any adverse risks in a fall incident, again eliminating potential shuttle disengagement.

In FIG. 3A, the cranked offset attachment arm 315 is retained in this embodiment, but is somewhat modified. The shuttle sits on top of the wire cable/rope 111 as other embodiments, with the slot 112 at the 6 o'clock position for smooth passage through the bracket (e.g., bracket 120, FIG. 1A). A 360° swivel 325 in the attachment arm 315 (including the curved portion 320 and the connector opening 335) ensures that the line of the pulling force in an attached lanyard (attached to connector opening 335) is conducive to smooth passage of the shuttle, whatever the operator's position in respect to the HLL.

As shown in FIG. 3B, should a user fall, the shuttle is pulled by the action of the safety lanyard and revolves around the wire cable/rope 111. The cranked offset attachment arm 315 will swivel downwards.

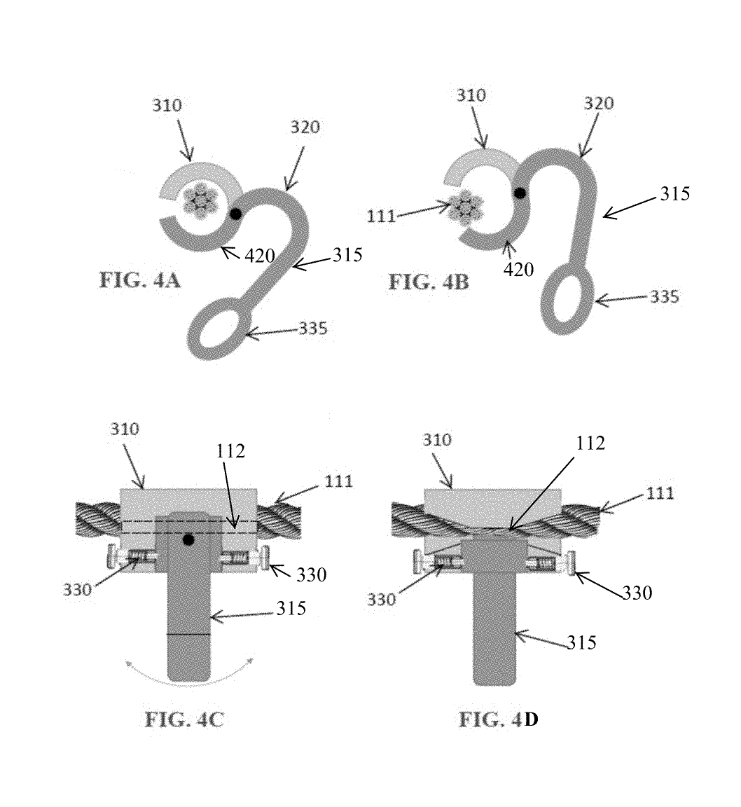

Due to the rotating action of the cranked offset attachment arm 315 and its cranked geometry, the direction of the fall-arrest load will be aligned with the center of the wire cable/rope 111, which will ensure that the slot 112 in the body 115 of the shuttle will not bear on the wire cable/rope 111. That is, the friction of the wire cable/rope 111 on the body 115 is less than if the wire cable/rope 111 is positioned at/in the slot 112, which would cause a portion of the wire cable/rope 111 to enter the slot 112 producing additional friction/force (as shown in FIG. 4D).

FIGS. 4A-D show another example of an offset attachment point for the shuttle and an integral on/off mechanism (i.e., a mechanism for removing/attaching the shuttle on or off the wire cable/rope 111), according to an embodiment. FIGS. 4A, 4C, and 4D show that the shuttle comprises of a fixed portion 310 and a movable portion including the curved portion 320. FIG. 4D shows the front of the slot 112 and FIG. 4C the back/rear of the shuttle. Both FIGS. 4C and 4D assume that there is a load on the arm for ease of understanding.

FIG. 4A shows a section through the shuttle to show that the arm 315 is integral to a movable lower jaw 420. Upon activation of two spring-loaded plungers (components 330), the lower jaw 420 can rotate open to allow the shuttle to be removed off or placed on the wire cable/rope 111 (FIG. 4B).

In one embodiment, upon re-engaging the shuttle onto the HLL the movable lower jaw 420 snaps shut and the spring-loaded plungers 330 re-engage.

One of the main problems with all on-off mechanisms is that they increase the risk of shuttle disengagement from the HLL as: (a) there is a general weakening of the shuttle, (b) the locking mechanisms may malfunction or (c) an operator may fail to close the device properly. In order to overcome these issues, in one embodiment the arm 315 is made integral to the movable lower jaw 420. The geometry of the arrangement is such that if the lower jaw 420 is inadvertently open or unlocked, any load applied in a fall incident will act on the arm 315, causing the lower jaw 420 to be forced to the closed position (FIG. 4A).

One or more embodiments provide for the use of an HLL shuttle on either side of a roof-mounted knee-level HLL without the necessity for manually removing and re-engaging the shuttle, whilst at the same time and according to the access route and the worker's preferences, providing the new device to be manually removable and re-engageable at any point along the horizontal lifeline, whilst at the same time in a fall-arrest loading scenario minimizing the catastrophic potential for the shuttle to inadvertently disengage from the system as a result of the risks introduced by either-sided use and manual re-engagement of the shuttle after manual removal.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be emphasized that the above-described embodiments of the present invention, particularly, any “preferred” embodiments, are merely possible examples of implementations, merely set forth for a clear understanding of the principles of the invention.

Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A shuttle device for a horizontal lifeline (HLL), comprising:
a body portion including a slot configured to bypass an intermediate bracket of the HLL; and
an attachment shackle coupled with the body portion, wherein the attachment shackle is configured to rotate the body portion under a fall-arrest load such that the slot is positioned away from bearing on a cable of the HLL.

2. The shuttle device of claim 1, further comprising a connection element coupled to the body portion with a frangible component.

3. The shuttle device of claim 2, wherein the frangible component uncouples the connection element from the body portion under a fall-arrest load.

4. The shuttle device of claim 1, wherein the attachment shackle comprises a cranked offset attachment arm.

5. The shuttle device of claim 4, wherein the cranked offset attachment arm comprises a curved portion and a lanyard connection opening.

6. The shuttle device of claim 5, wherein a direction of a fall-arrest load is aligned with a center of the cable such that the slot has no bearing on the cable.

7. The shuttle device of claim 1, wherein the attachment shackle comprises a swivel.

8. The shuttle device of claim 7, wherein the attachment shackle further comprises one or more spring-loaded plungers.

9. The shuttle device of claim 8, wherein the attachment shackle comprises a fixed portion and a movable lower jaw portion, and the movable lower jaw portion is configured to rotate to an open state.

10. A shuttle device for a horizontal lifeline (HLL), comprising:
a body portion including a slot configured to bypass an intermediate bracket of the HLL; and
an attachment shackle coupled with the body portion, wherein the attachment shackle is configured to rotate the slot under a fall-arrest load such that the slot is not aligned with a cable of the HLL.

11. The shuttle device of claim 10, further comprising a connection element coupled to the body portion with a frangible component, wherein the frangible component uncouples the connection element from the body portion under a fall-arrest load.

12. The shuttle device of claim 10, wherein the attachment shackle comprises a cranked offset attachment arm including a curved portion and a lanyard connection opening.

13. The shuttle device of claim 12, wherein the attachment shackle comprises a swivel.

14. The shuttle device of claim 13, wherein the attachment shackle further comprises one or more spring-loaded plungers.

15. The shuttle device of claim 14, wherein the attachment shackle comprises a fixed portion and a movable lower jaw portion, and the movable lower jaw portion is configured to rotate to an open state.

16. A shuttle device for a horizontal lifeline (HLL) including a cable and at least one intermediate bracket, the shuttle device comprising:
a body portion including a slot configured to fit over the intermediate bracket of the HLL; and
an attachment shackle coupled with the body portion, wherein the attachment shackle is configured to rotate the body portion under a fall-arrest load to prevent the slot from aligning directly with the cable.

17. The shuttle device of claim 16, further comprising a connection element coupled to the body portion with a frangible component, wherein the frangible component uncouples the connection element from the body portion under a fall-arrest load.

18. The shuttle device of claim 16, wherein the attachment shackle comprises: a cranked offset attachment arm including a curved portion and a lanyard connection opening, and a swivel component.

19. The shuttle device of claim 18, wherein the attachment shackle further comprises one or more spring-loaded plungers.

20. The shuttle device of claim 19, wherein the attachment shackle comprises a fixed portion and a movable lower jaw portion, and the movable lower jaw portion is configured to rotate to an open state.
